(19) United States
(12) Patent Application Publication
(10) Pub. No.: US 2026/0226684 A1
(43) Pub. Date: Aug. 6, 2026

(54) METHOD FOR PRODUCING A SOLID CELLULOSE FOAM, A SOLID CELLULOSE FOAM, AND USE THEREOF

(71) Applicant: Stora Enso OYJ, Helsinki (FI)

(72) Inventor: Martin Sterner, Farsta (SE)

(73) Assignee: Stora Enso OYJ, Helsinki (FI)

(21) Appl. No.: 19/154,031

(22) PCT Filed: Feb. 16, 2024
(86) PCT No.: PCT/IB2024/051478

§ 371 Date: Aug. 6, 2025

(30) Foreign Application Priority Data
Feb. 16, 2023 (SE) 2330084-1

(51) Int. Cl. D21F 11/00; D21F 1/48; D21H 27/40

(52) U.S. Cl. CPC D21F 11/002; D21F 1/48; D21F 11/006; D21H 27/40

(57) ABSTRACT

The present invention relates to a method for producing a solid cellulose foam. The method comprises depositing a first wet cellulose foam to obtain a first wet foam deposition, which is subsequently provided with cutting lines extending at least partially through the height of the first wet foam deposition, to form pillars of wet cellulose foam. During drying of the first wet foam deposition, gaps are formed along the cutting lines so that the pillars are separated by said gaps. In a subsequent deposition step, a second wet cellulose foam is deposited so as to obtain a subsequent wet foam deposition that fills the gaps between the pillars. After drying, a solid cellulose foam comprising pillars of a first solid foam deposition and a subsequent solid cellulose foam deposition filling the gaps between the pillars is obtained.

### FIELD OF THE INVENTION

The present invention relates to a method for producing a solid cellulose foam, and a solid cellulose foam comprising a first solid foam deposition and a subsequent solid foam deposition. The solid cellulose foam of the present invention may for example be used as a cushioning material in packaging applications.

### BACKGROUND

Different porous materials, such as foams, are commonly used in applications such as insulation in buildings and vehicles and as packaging materials that are used to protect various goods during storage and transportation.

Depending on the item to be protected, different types of protective packaging materials can be used. For many items, a low-weight cushioning material that reduces impact shock and vibrations is used. Common examples of such cushioning materials are petroleum-based polymer foams such as polyurethane, polyethylene and expanded polystyrene. The foams used should be low-weight, dimensionally stable and easy to manufacture.

Today, there is an increasing interest in replacing petroleum-based polymers with polymers from renewable resources, i.e. biobased polymers. Cellulose is the most abundant renewable natural polymer on earth and is therefore of special interest. For a cellulose foam, recycling of the material in regular recycling streams may be possible, depending on the composition of the foam.

There are several examples of cellulose foams, prepared using different methods. Drying the wet foam is often a critical step. Since the stability of the wet foam is typically low, moulds are commonly used to prevent the foam from collapsing during drying. WO20200011587 A1 describes a porous material that is prepared by aerating a paste comprising cellulose fibres and gluten and depositing the aerated paste in a mould where it is dried. The dried porous material has the shape of the mould. WO2015036659 A1 describes a moulded fibrous product prepared by foaming an aqueous suspension of natural fibres in combination with synthetic fibres and surfactant, feeding the fibrous foam to a mould and drying the foam by first mechanically withdrawing a part of the water followed by evaporating water to produce a dry fibrous product.

When drying a cellulose foam without restrictions, the cellulose foam will shrink in all directions, due to collapse of the foam, as tension forces pull the cellulose fibres together. Drying shrinkage is an inherent property of cellulose, as swollen cellulose fibres will collapse onto each other when water is removed from the system. Even in more complicated drying systems such as combined air impingement and IR-dryers, a shrinkage in the thickness direction of above 10% is expected. This is because of the capillary pressure build-up inside the material as the water level recedes during drying, leading to menisci forming between particles and as a result attractive inter particle forces. Increasing the dry component of foam having less affinity to water and/or hydrophobic character reduces the attractive forces occurring due to capillary pressure between particles. However, the network strength forming during drying is reduced due to reduction in the fiber-fiber joint strength as well as the number average of fiber-fiber joint.

To avoid or reduce shrinkage during drying, the cellulose foam needs to dry under tension, such as in a frame or mould. The use of such restriction means will to a great extent prevent shrinkage of the foam in the width and length directions. When drying an object with a large surface area the tension obtained by the frame or mould is however limited to the regions closest to the mould. Typically, the thickness of the foam will be reduced due to shrinkage in the middle of the object, with a gradual increase in thickness towards the edges, as illustrated for a prior art foam in FIG. 1. Thus, shrinkage during drying is a problem, especially when drying foam objects with large surface areas since the shrinkage is non-uniform and the thickness of the dried foam may vary along the width and length of the dry foam.

The drying time of a cellulose foam is typically long since both wet cellulose foams and dry cellulose foams are heat insulating. A short drying time is desired to enable a cost-efficient process.

Thus, there is still a need for alternative methods for the preparation of a cellulose foam. In addition, the prepared foam should have a high impact resistance when used as a packaging material to enable protection also of heavier portions.

### SUMMARY OF THE INVENTION

It is an object of the present invention to provide a solid cellulose foam, which is recyclable and made from renewable sources, and which eliminates or alleviates at least some of the disadvantages of the prior art materials.

It is a further object of the present invention to provide an improved method of obtaining a solid cellulose foam with a uniform thickness and minimized non-uniform shrinkage during drying, also when producing large foam articles.

It is a further object of the present invention to provide a cost-efficient method of obtaining a solid cellulose foam where the drying time of the foam is reduced.

The above-mentioned objects, as well as other objects as will be realized by the skilled person in light of the present disclosure, are achieved by the various aspects of the present disclosure.

The present invention is defined in the independent claims. Further embodiments of the invention are defined in the dependent claims.

According to a first aspect, the present invention relates to a method for producing a solid cellulose foam having a height hₛ, a length lₛ, and a width wₛ, wherein the method comprises the steps of:
a) providing a first wet cellulose foam;
b) depositing the first wet cellulose foam on a surface so as to obtain a first wet foam deposition having a height h_{1W}, a length l_{1W}, a width w_{1W}, a top surface and a bottom surface;
c) forming pillars in the first wet foam deposition by providing the top surface of the first wet foam deposition with cutting lines extending at least partially through the height h_{1W} of the first wet foam deposition;
d) drying the first wet foam deposition so as to obtain a first solid foam deposition comprising pillars separated by gaps, wherein the gaps are formed along the cutting lines, and wherein the first solid foam deposition has a height h_{1S}, a length l_{1S}, a width w_{1S}, a top surface and a bottom surface;
e) providing a second wet cellulose foam;
f) depositing the second wet cellulose foam so as to obtain a subsequent wet foam deposition that fills the gaps between the pillars in the first solid foam deposition;
g) drying the subsequent wet foam deposition so as to obtain a solid cellulose foam comprising pillars of a first solid foam deposition and a subsequent solid foam deposition filling the gaps between the pillars.

It has surprisingly been found that non-uniform shrinkage in the height direction of a wet cellulose foam object during drying can be significantly reduced by the method according to the first aspect, involving two foam depositions instead of only one. By providing the first wet foam deposition with cutting lines, gaps are formed along the cutting lines when the wet cellulose foam is dried. The surface area of the resulting pillars delimited by the cutting lines, and subsequently formed gaps, is significantly smaller than the surface area of the entire wet foam deposition prior to providing the cutting lines. A small surface area is beneficial in terms of minimizing non-uniform shrinkage during drying. The dried pillars of the first solid foam deposition provides support for the subsequent wet foam deposition during drying, so that no shrinkage will occur. A lightweight and dimensionally stable solid cellulose foam can be obtained with the method according to the present invention. The obtained solid cellulose foam has a uniform height.

It has also surprisingly been found that the drying time of a wet cellulose foam is decreased by the method according to the first aspect. When drying a large object of wet cellulose foam, drying is slow due to the foam being thermally insulating. When drying the pillars of the first wet foam deposition according to the present invention, the surface area in contact with air is significantly increased due to the presence of the pillars, and drying is faster. Since the pillars are placed close to each other, the total volume of the subsequent wet foam deposition is small. This enables a shorter total drying time for the cellulose foam according to the present two-step deposition method, as compared to a cellulose foam having the same properties but deposited using one deposition step. A short drying time is beneficial from a cost perspective.

According to a second aspect, the present invention relates to a solid cellulose foam having a height hₛ, a length lₛ, and a width wₛ, the solid cellulose foam comprising a first solid foam deposition and a subsequent solid foam deposition, wherein the first solid foam deposition comprises pillars, wherein the pillars are separated by gaps, and wherein the gaps are filled with the subsequent solid foam deposition.

The solid cellulose foam according to the second aspect has a high impact resistance and excellent cushioning properties, and can be used as a packaging material in various protective packaging applications. It can also be used as a building material, or as a thermal or acoustic insulation material. The solid cellulose foam may also be used as a hydroponic plant growth media. The solid cellulose foam is made from renewable resources and can be re-dispersed in water and as a result be recyclable in regular paper recycling streams.

According to a third aspect, the present invention relates to a use of the solid cellulose foam according to the second aspect as a packaging material, a building material, a thermal insulation material, an acoustic insulation material or as a hydroponic plant growth media.

The cellulose foam of the present invention preferably comprises in the range of from 71 to 95 wt % cellulose fibres, as calculated on the total weight of solid content in the foam, in the range of from 4 to 24 wt % of a water-soluble thickener, as calculated on the total weight of solid content in the foam, and at least two surfactants.

### BRIEF DESCRIPTION OF THE DRAWINGS

The embodiments of the present invention are best understood by reference to the following description and the enclosed drawings. The invention will be described in more detail with reference to the enclosed drawings. In the drawings, a dotted object represents a wet foam, whereas a solid object represents a dry foam.

FIG. 1 schematically illustrates a prior art method where a wet cellulose foam sheet is deposited and dried, with non-uniform shrinkage in the height direction.

FIG. 2a-e schematically illustrates top views (top figure) and side views (bottom figure) of a solid cellulose foam plank at various points during manufacturing. A first wet cellulose foam is deposited (FIG. 2a), and provided with cutting lines to form pillars of cuboid shape in the first wet foam deposition (FIG. 2b). The cutting lines extend partially through the height of the first wet foam deposition. After drying, a first solid foam deposition is obtained (FIG. 2c), comprising pillars separated by gaps corresponding to the cutting lines. The gaps are formed during drying due to contraction of the wet cellulose foam. FIG. 2d illustrates an intermediate product where a second wet cellulose foam has been deposited in the gaps between the pillars, and also on top of the pillars. FIG. 2e illustrates a solid cellulose foam comprising a first solid foam deposition comprising pillars and a bottom portion; and a subsequent solid foam deposition filling the gaps between the pillars and comprising a top portion arranged on top of the pillars.

FIG. 3 schematically illustrates an alternative embodiment where cutting lines are provided in first wet foam deposition in a zigzag pattern, with adjacent cutting lines offset from each other. A first set of cutting lines are provided (dotted lines), followed by a second set of cutting lines (dashed lines) where the second set of cutting lines are offset from the first set of cutting lines. Pillars of cuboid shape are created by the cutting lines.

FIG. 4 schematically illustrates an alternative embodiment where pillars are extending along the length of the first wet foam deposition, such that the first solid foam deposition has a ribbed appearance.

FIG. 5 shows drying curves obtained during drying of a wet cellulose foam deposited in one single step (○), or in two steps with a first foam deposition (□) being air cut prior to drying, and a second deposition (Δ) filling the gaps between pillars formed during air cutting.

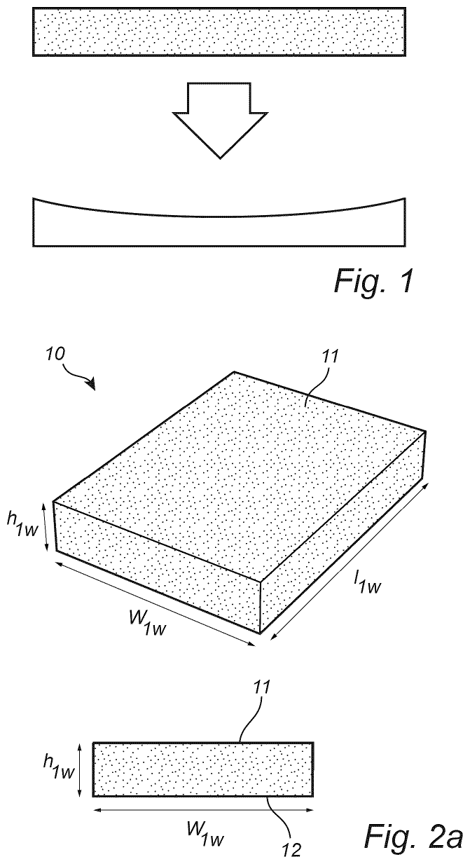

### DETAILED DESCRIPTION

The term “foam”, as used herein, refers to a substance made by trapping air or gas bubbles inside a solid or liquid. Typically, the volume of gas is much larger than that of the liquid or solid, with thin films separating gas pockets. Three requirements must be met in order for foam to form. Mechanical work is needed to increase the surface area. This can occur by agitation, dispersing a large volume of gas into a liquid, or injecting a gas into a liquid. The second requirement is that a foam forming agent, typically an amphiphilic substance, a surfactant or surface-active component, must be present to decrease surface tension. Finally, the foam must form more quickly than it breaks down.

The term “cellulose foam”, as used herein, refers to a foam comprising cellulose, and other components such as thickeners, surfactants and additives. The main component of the cellulose foam is cellulose, such that cellulose constitutes at least 70 wt % of the dry content of the cellulose foam. Cellulose is in the form of fibres, and the foam can thus also be defined to be a fibrous foam or a cellulose fibre foam. The cellulose foam may be wet or solid.

The term “wet foam”, or “wet cellulose foam”, as used herein, refers to a wet foam comprising cellulose, and other components such as thickeners, surfactants and additives. Gas bubbles are present within the wet foam. The wet foam is freestanding and behaves as a viscoelastic solid. This means that the wet foam has both viscous and elastic properties. The wet foam will behave as a solid, and thus be freestanding, unless a large enough force is applied so that it starts to flow and instead behave as a viscous material. Depending on the magnitude and timescale of any applied shear stress, the wet foam can show a predominantly viscous or elastic behaviour.

The term “solid cellulose foam”, or “solid foam”, as used herein, refers to a dry porous cellulose material that has been formed from a wet cellulose foam, i.e. a foam formed material. During the drying process, a closed wet cellulose foam is transformed into an open solid cellulose foam. The network of cellulose fibres is prevented from collapsing during drying. The solid cellulose foam will as a result have a shape that to a large extent corresponds to that of the wet cellulose foam. The dry content of the solid cellulose foam is at least 95 wt % as calculated based on the total weight of the solid cellulose foam. The shape and density of the solid cellulose foam is retained also in a non-confined state. The solid cellulose foam has an open cell structure, allowing air to occupy the pores within the foam. The solid cellulose foam can also be described as a porous material or a low-density material.

The cellulose foam preferably used in the first and subsequent depositions of the method according to the present invention will now be described in detail.

The cellulose foam used in the present invention may comprise cellulose fibres in a range of from 71 to 95 wt %, such as from 75 to 95 wt %, based on the total dry weight of the cellulose foam.

Cellulose fibres suitable for use in the present invention can originate from wood, such as softwood or hardwood, from leaves or from fibre crops (including cotton, flax and hemp). The cellulose fibres suitable for use in the present invention can also originate from regenerated cellulose such as rayon and Lyocell. The cellulose fibres suitable for use in the present invention may include lignin or hemicellulose or both, or the cellulose fibres may be free from lignin and hemicellulose. Preferably, the cellulose fibres originate from wood, more preferably the cellulose fibres are pulp fibres obtained by pulping processes which liberates the fibres from the wood matrix. Pulp fibres can be liberated by mechanical pulping, obtaining mechanical pulp such as thermomechanical pulp (TMP) or chemical thermomechanical pulp (CTMP), or by chemical pulping such as Kraft pulp or pulps obtained by the sulphite process, soda process or organosolv pulping process. More preferably, the cellulose fibres are pulp fibres liberated by chemical pulping processes. The different characteristic of each cellulose fibre will affect the properties of the final cellulose foam. A cellulose fibre is significantly longer than it is wide. Cellulose fibres can have a mean width of 0.01 to 0.05 mm. The fibre length of softwood can be from 2.5 to 4.5 mm, while hardwood can have a fibre length from 0.7 to 1.6 mm, and Eucalyptus from 0.7 to 1.5 mm. However, the fibre length can vary considerably with different growing place etc. The cellulose fibres in the cellulose foam disclosed herein can have a length from 0.1 mm to 65 mm, or from 0.1 mm to 10 mm, or from 0.5 mm to 65 mm, or from 0.5 mm to 10 mm, or from 0.5 mm to 7 mm. The fibre lengths may provide different mechanical characteristics to the foam. Due to the length of fibres, they can entangle with each other and impart fibre to fibre interbonds that bring strength to the foam. The aspect ratio, i.e. the ratio of the fibre length to the fibre width, of the cellulose fibres in the cellulose foam according to the present invention can be at least 10, at least 25, at least 50, at least 75, or at least 100, which provides for preservation and stabilization of the foam structure during the drying procedure, making it possible to dry the wet cellulose foam with retained shape. The aspect ratio can be up to 6500, or preferably up to 2000.

The cellulose fibres may be modified to provide different properties to the final cellulose foam. For example, phosphorylated fibres or periodate oxidized fibres could also be used when producing a cellulose foam according to the present invention.

Preferably, the cellulose fibres are selected from wood pulp, such as softwood Kraft bleached pulp, hardwood pulp, chemical-thermomechanical pulp, and from dissolving pulp, or a combination of one or more of these. More preferably the cellulose pulp fibres are from softwood pulp, chemical-thermomechanical pulp, or dissolving pulp. Most preferably the cellulose pulp fibres are from softwood pulp, such as softwood Kraft bleached pulp.

The cellulose foam used in the present invention preferably comprises cellulose fibres in a range of from 71 to 95 wt %, such as from 75 to 95 wt %, based on the total dry weight of the cellulose foam, a water-soluble thickener in a range of from 4 to 24 wt %, such as from 5 to 20 wt %, based on the total dry weight of the cellulose foam, and at least two surfactants.

The water-soluble thickener may have a molecular weight of from 80 000-250 000 g/mol, or from 83 000-197 000 g/mol. Exemplary water-soluble thickeners are selected from carboxy methyl cellulose (CMC), methyl cellulose (MC), hydroxyethyl cellulose (HEC), ethyl hydroxyethyl cellulose (EHEC), methyl hydroxypropyl cellulose (MHPC), starch, xanthan, guar gum, and xyloglucan, or mixtures thereof. The fact that the thickener is water-soluble facilitates recycling of the cellulose foam.

The water-soluble thickener may improve the fibre-fibre bonding strength, primarily through hydrogen bonding, in the cellulose foam. Therefore, the amount of water-soluble thickener will influence the mechanical performance of the cellulose foam, and especially the bulk of the material. A higher content of water-soluble thickener provides for a stiffer material. Thus, the water-soluble thickener enables tailoring of the mechanical properties.

The cellulose foam may also comprise a mixture of at least two surfactants. One of the at least two surfactants is preferably a fast-acting surfactant, a suitable surfactant for this purpose is an anionic surfactant, preferably a low-molecular weight anionic surfactant. The anionic surfactant may have an apparent pKa of from 3.2 to 3.8, preferably from 3.4 to 3.6, or an apparent pKa of 3.5 in a solution having a pH of from 7 to 9, preferably a pH of 8. The low-molecular weight anionic surfactant may be selected from sodium dodecyl sulphate (SDS); potassium dodecyl sulphate, sodium laureth sulphate (SLES); sodium dodecylbenzenesulphonate; sodium cocoyl sarcosinate; sodium lauroyl sarcosinate. The low-molecular weight anionic surfactant is preferably selected from sodium dodecyl sulphate (SDS); sodium p-n-dodecylbenzenesulphonate; sodium cocoyl sarcosinate; and sodium lauroyl sarcosinate. More preferably the low-molecular weight anionic surfactant is sodium cocoyl sarcosinate. The anionic surfactant may be biodegradable.

The other one of the at least two surfactants is preferably a co-surfactant. The co-surfactant may be selected from the group comprising surfactants having an apparent pKa of at least 8, or at least 9, in a surfactant solution having pH of from 7 to 9, preferably having a pH of 8; and amphoteric betaines. The co-surfactant may have maximum apparent pKa of 10. The co-surfactant preferably has a long carbon chain, more preferably a carbon chain with 14 carbon atoms (C14). The co-surfactant may be selected from high pKa fatty acids, such as from plant derived feedstock, e.g. tetradecanoic acid (myristic acid), sodium oleate, lauric acid, palmitic acid, and stearic acid; glucose based co-surfactants with an aliphatic carbon tail, such as alkyl glycosides, alkylpolyglucosides, alkyl thio-glycosides, and alkyl maltosides; amphoteric betaines, such as cocamidopropyl betaine (CAPB), and sodium cocoiminodipropionate (CADP); polyethylene glycol sorbitan monolaurate, i.e. tween® (e.g. tween® 20, tween® 80 and tween® 85); and polyoxyethylene lauryl ethers, such as polyethylene glycol dodecyl ether, pentaethylene glycol monododecyl ether and octaethylene glycol monododecyl ether.

Thus, the at least two surfactants used in the cellulose foam preferably comprise a mixture of an anionic surfactant and a co-surfactant. The molar ratio between anionic surfactant to co-surfactant may be from 0.2:1 to 3:1, preferably from 0.5:1 to 2:1. The total amount of the at least two surfactants together in the cellulose foam may be 0.6-5 wt %, or 0.8-2.0 wt %, as calculated on the total weight of the cellulose foam.

The solid cellulose foam can be re-dispersed in water and as a result be recyclable in regular paper recycling streams.

The wet cellulose foam may be prepared using a method comprising the following steps:
disintegrating cellulose fibres in water to obtain a slurry of cellulose fibres;
adding a water-soluble thickener to the slurry to obtain a mixture of thickener and cellulose fibres in water;
adding at least two surfactants to the mixture to obtain a fibre suspension; and
aerating the fibre suspension to obtain a wet foam, wherein the wet cellulose foam comprises 10-38 wt % cellulose fibres, 0.5-10 wt % of the water-soluble thickener, and 0.1-2 wt % surfactants, as calculated on the total weight of the wet foam, and wherein the wet cellulose foam has a density of from 120-500 kg/m³, or from 120-400 kg/m³, and a yield stress of at least 80 Pa.

Addition of a water-soluble thickener increases the viscosity of the slurry and enables incorporation of enough air to generate a densely packed foam during aeration. Since the cellulose fibres are mixed in high concentrations a drainage step is not needed, which enables the use of a water-soluble bio-based thickener in high concentrations.

Addition of a fast-acting surfactant will contribute to the formation of a cellulose foam with a high density and a high viscosity as it will quickly settle at the air-water interphase during aeration. This enables a free-standing wet cellulose foam. Addition of a co-surfactant along with the fast-acting surfactant will further improve the properties of the cellulose foam since it will facilitate the action of the fast-acting surfactant. A co-surfactant having a suitable pKa and a long carbon chain further contributes to a stable fibre suspension and a stable wet cellulose foam.

Upon aeration the composition comprising cellulose fibres, thickener and at least two surfactants will form a highly stable wet fibre foam. The aeration may be performed by mechanical agitation, and a substantial amount of air is incorporated into the material. The formation of a foam will be promoted by the surfactants. By adjusting the stability of the wet foam with the use of thickeners and surfactant combinations, a free-standing cellulose foam can be made without the use of a cross-linker or fibrillated cellulose. A good stability of the foam prevents ripening, i.e. change in bubble size, and drainage. The obtained wet foam is free-standing and does not require a mould or a forming fabric to retain its shape upon drying. The wet foam can thus be formed into a free-standing foam that is stable enough to be dried in the absence of a supporting mould without collapsing.

The bubble size in the wet foam is typically below 100 μm. This provides for a homogenous wet foam with good stability that does not flocculate during processing.

During processing, and also during the subsequent drying step, the average bubble size is maintained to a large extent and the cellulose fibres remain well dispersed. The resulting solid cellulose foam obtained by drying the wet foam will be homogenous in structure, strong, have good mechanical properties, a smooth surface and no defects.

In comparison, a wet cellulose foam with low stability has a larger average bubble size (i.e. typically above 100 μm) and the bubbles will coalesce faster during processing and drying such that larger bubbles are formed. In addition, the cellulose fibres will form clusters during processing and drying. This results in the wet foam collapsing during drying. The resulting solid cellulose foam will not have a homogenous structure and will also contain defects in the form of cavities resulting from the coalesced bubbles in the wet foam. Such a solid cellulose foam is, due to the defects, weak and has a rough surface.

In some embodiments, the yield stress of the wet cellulose foams used in the present invention may be at least 80 Pa, or at least 100 Pa, or at least 150 Pa, or from 80 to 500 Pa, or from 100 to 500 Pa, or from 150 to 500 Pa.

In some embodiments, the density of the wet cellulose foams used in the present invention may be from 70-600 kg/m³, or from 100-500 kg/m³, or from 100-400 kg/m³, or from 125-375 kg/m³, or from 140-375 kg/m³.

In some embodiments, the wet cellulose foam used in the present invention comprises at least 10 wt % cellulose, as calculated on the total weight of the wet cellulose foam. In some embodiments, the wet cellulose foam may comprise 10-40 wt %, 11-40 wt %, 10-30 wt %, 11-30 wt %, 10-20 wt %, or 11-20 wt % cellulose fibres, as calculated on the total weight of the wet cellulose foam.

Because of the high solid content, the wet foam does not need to be dewatered before it is dried. The foam may be dried by evaporation at room temperature or at an elevated temperature, such as a temperature of from 40° C. to 140° C. After drying, the solid cellulose foam may have a density of from 10 to 80 kg/m³, or from 10 to 60 kg/m³ or from 20 to 50kg/m³. In preferred embodiments the cellulose foam comprises cellulose fibres in a range of from 71 to 95 wt %, such as from 75 to 95 wt %, based on the total dry weight of the cellulose foam, a water-soluble thickener in a range of from 4 to 24 wt %, such as from 5 to 20 wt %, based on the total dry weight of the cellulose foam, and at least two surfactants. A wet cellulose foam having such a composition is homogenous in structure and has a good stability as discussed above. Such a wet cellulose foam can also be dried without prior dewatering.

The solid cellulose foam may after drying have a solid content in the range of from 95 to 100 wt %, preferably from 98 to 100 wt %, as calculated on the total weight of the solid cellulose foam.

During drying a densified layer is formed on the outer surface of the wet cellulose foam and remain on the outer surface of the dried cellulose foam. The densified layer comprises cellulose fibres that are packed more tightly and partly oriented differently compared to the bulk. The densified layers have improved mechanical stability and strength as compared to the core of the cellulose foam. The core of the cellulose foam comprises a homogenous open-cell fibre network. The core is highly porous, and even though the densified layer has a denser structure than the core, it is still porous. The densified layer provides the cellulose foam with increased stability and mechanical strength.

The cellulose foam described above is the preferred foam to use in the cellulose foam depositions of the present invention. Alternatively, other cellulose foams, such as those disclosed in WO2016068771 A1, WO2016068787 A1, and WO2020011587 A1 may be used.

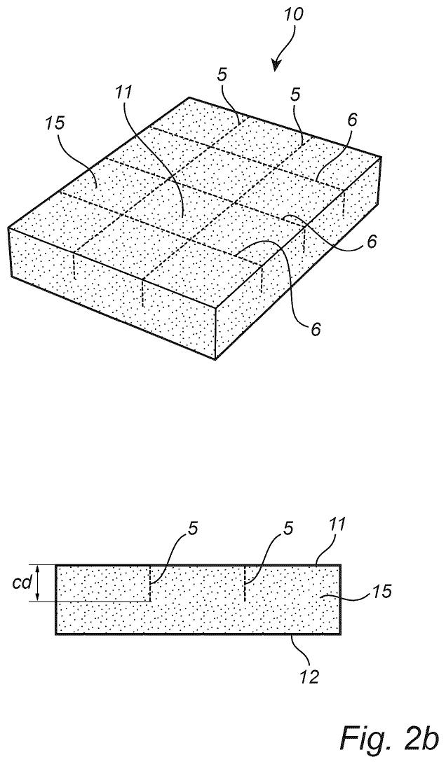

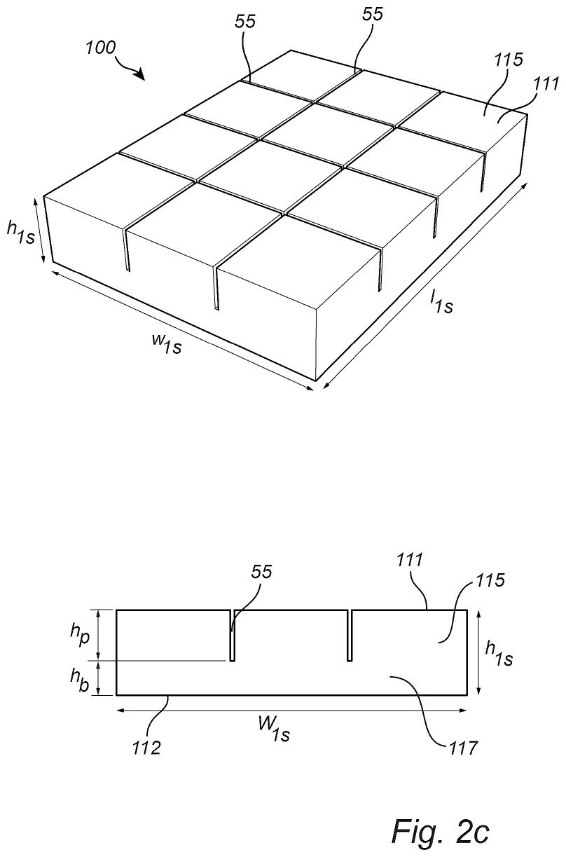

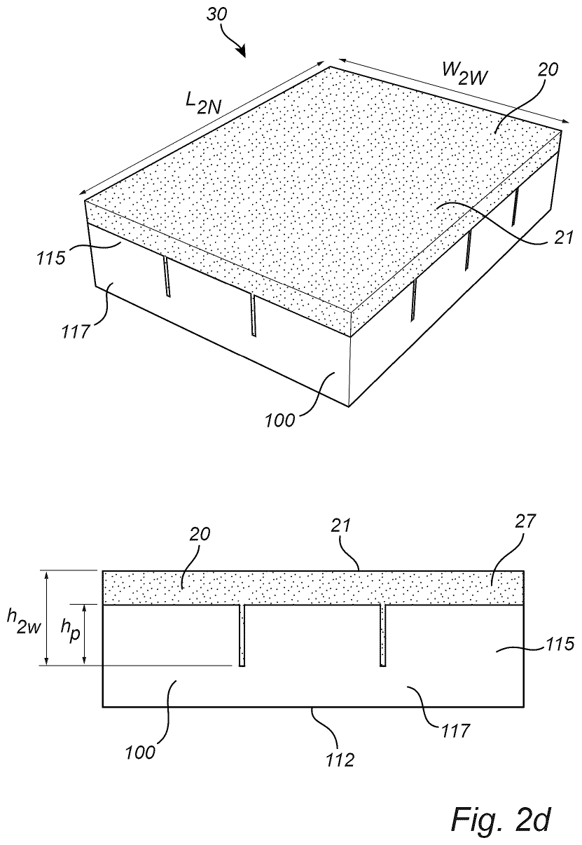

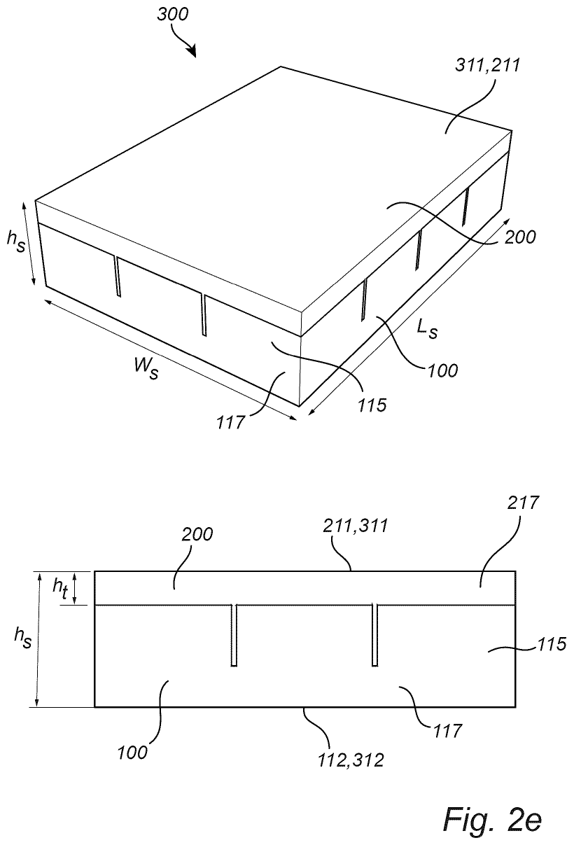

The method according to the first aspect will now be described in detail with reference to FIG. 2. Step a) of the method according to the first aspect involves providing a first wet cellulose foam, the details of which are further described above.

Step b) of the method according to the first aspect involves depositing the first wet cellulose foam on a surface so as to obtain a first wet foam deposition 10 having a height h_{1W}, a length l_{1W}, a width w_{1W}, a top surface 11 and a bottom surface 12. The first wet cellulose foam is deposited onto a surface, such as a perforated metal tray or a conveyor belt. The tray may be fitted with an outer frame to provide additional support during deposition and drying. The first wet cellulose foam may be deposited using any suitable means, such as by extrusion. The height of the first wet foam deposition 10 may be in the range of from 1 to 20 cm, or from 1 to 10 cm, or from 1 to 6 cm, or from 4 to 6 cm. The dimensions of width and length of the first wet foam deposition 10 are not particularly limited, but may both be in the range of from 60 cm to 400 cm, such as from 100 cm to 300 cm, depending on the equipment used for production and the desired dimension of the solid cellulose foam 300 to be produced. The first wet cellulose foam is preferably deposited such that the first wet foam deposition 10 has the shape of a sheet or plank, such as illustrated in the embodiment in FIG. 2a. The term “plank” as used herein, refers to an object where the dimensions of length and width are significantly larger than the height, and where the length may be significantly larger than the width.

The method according to the first aspect may be used in a continuous process. In such a process, the first wet cellulose foam is typically deposited on a moving surface, such as a conveyor belt.

Step c) of the method according the first aspect involves forming pillars 15 in the first wet foam deposition 10 by providing the top surface 11 of the first wet foam deposition 10 with cutting lines 5, 6 extending at least partially through the height h_{1W} of the first wet foam deposition 10. The cutting lines 5, 6 thus extend from the top surface 11 of the first wet foam deposition 10 towards the bottom surface 12 of the first wet foam deposition 10. The cutting lines 5, 6 will delimit the outer edges of the formed pillars 15. A cutting depth cd of the cutting lines 5, 6 is measured from the top surface 11 of the first wet foam deposition 10, in the direction towards the bottom surface 12 of the first wet foam deposition 10. The cutting is preferably made in a direction that is perpendicular to the top surface 11 of the first wet foam deposition 10. In an alternative embodiment, the cutting is made at an angle to the top surface 11 of the first wet foam deposition 10.

The term “pillar” as used herein refers to an individual three-dimensional protruding foam unit. The pillars may comprise wet foam or solid (i.e. dry) foam. In the wet cellulose foam, pillars are separated from other adjacent pillars by cutting lines. In the solid cellulose foam, the pillars are separated from other adjacent pillars by gaps. The gaps between the pillars in the solid cellulose foam is filled with a subsequent foam deposition. In the solid cellulose foam, the pillars are distinguishable from each other and from the subsequent foam deposition. All pillars in the solid cellulose foam may extend from a bottom portion of the foam, or the pillars may be completely separated from each other. The pillars may have any suitable shape and dimension. For example, the pillars may have a cuboid shape, where the dimension of height, width and length are all similar. Alternatively, the pillars may have a cuboid shape where the dimension of height and width are similar, but where the length is significantly greater.

A height of the pillars 15 in the first wet foam deposition 10 will correspond to the cutting depth cd.

In some embodiments, the cutting lines 5, 6 extend to a cutting depth cd corresponding to at least 70%, or at least 80%, or at least 90%, or at least 95%, of the height h_{1W} of the first wet foam deposition 10, as measured from the top surface 11 of the first wet foam deposition 10 towards the bottom surface 12 of the first wet foam deposition 10. By ensuring that the cutting depth cd is at least 70% of the height h_{1W} of the first wet foam deposition 10, the pillars 15 are sufficiently separated to prevent non-uniform shrinkage in the height direction from occurring during drying. When the cutting depth cd is less than 70% of the height h_{1W} of the first wet foam deposition 10, the pillars 15 may start to exhibit different amounts of shrinkage in the height direction, with more pronounced shrinkage of the pillars 15 in the middle of the first wet foam deposition 10. The obtained first solid foam deposition 100 would in that case have a non-uniform height.

In some embodiments, the cutting lines 5, 6 extend through the entire height h_{1W} of the first wet foam deposition. In such embodiments, the cutting depth cd corresponds to 100% of the height h_{1W} of the first wet foam deposition 10.

In some embodiments, the cutting lines 5, 6 extend to a cutting depth cd in the range of from 70% to 95%, such as from 80% to 95%, or from 85% to 95%, of the height h_{1W} of the first wet foam deposition 10, as measured from the top surface 11 of the first wet foam deposition 10 towards the bottom surface 12 of the first wet foam deposition 10. In such embodiments, the cutting lines 5, 6 do not extend through the entire height h_{1W} of the first wet foam deposition 10. When the cutting lines 5, 6 only extend partially through the height h_{1W} of the first wet foam deposition 10, the bottom surface 12 of the first wet foam deposition 10 will be coherent. A coherent bottom surface is smooth and it also facilitates subsequent handling during production since all pillars 15 are attached to it.

The cutting lines 5, 6 may be provided on the top surface 11 of the first wet foam deposition 10 in any suitable pattern, so as to form pillars 15 of any suitable three-dimensional shape. The number of cutting lines 5, 6 may also vary, depending on the size and number of pillars 15 to be formed. The cutting lines 5, 6 may be continuous. Preferably, the cutting lines 5, 6 extend from one side of the first wet foam deposition 10 across the entire top surface 11 to the opposite side of the first wet foam deposition 10. In one embodiment, the cutting lines 5, 6 are provided in the direction of the length l_{1W} and/or width w_{1W} of the first wet foam deposition 10. In one embodiment, the cutting lines 5, 6 are provided in both the direction of the length l_{1W} and in the direction of the width w_{1W} of the first wet foam deposition 10. The cutting lines 5, 6 may be provided as straight lines, or in any other shape, such as in a wave-shape, or a zigzag-shape. Several cutting lines 5, 6 parallel to each other may be provided. The spacing between parallel cutting lines 5, 6 may be the same along the entire top surface 11 of first wet foam deposition 10, or it may be different in different parts of the top surface 11. Cutting lines 5, 6 may intersect other cutting lines 5, 6. One cutting line 5, 6 may be off-set from an adjacent cutting line 5, 6.

All the formed pillars 15 in the first wet foam deposition 10 may have the same shape and dimension, or the shapes and dimensions may vary at different parts of the first wet foam deposition 10. Preferably, the shape and dimension of all pillars 15 in the first wet foam deposition 10 are the same. In some embodiments, each pillar 15 has the shape of a polyhedron, such as a cuboid, cube, or prism, such as a hexagonal prism. Small variations in the symmetry of a pillar 15 may exist without changing their main purpose to impart stability to the solid cellulose foam 300. For example, the cube, cuboid, or prism may be slightly distorted so that their opposite bases are not always exactly parallel and over each other. The top surface of each pillar 15, delimited by the cutting lines 5, 6, may for example be in the form of a rectangle, square, rhombus, octagon or hexagon. The cutting lines 5, 6 may be provided such that pillars 15 distributed in any suitable pattern are formed. The pattern may be selected from a honeycomb pattern, a diamond pattern, a ribbed pattern, or a square pattern.

In one embodiment, the width of each pillar 15 is in the range of from 90% to 130%, or from 90% to 120%, or from 90% to 110% of its height. When the width of each pillar 15 is similar to its height, non-uniform shrinkage in the height direction during drying is minimized. The width is measured at the top part of each pillar 15.

One embodiment is illustrated in FIG. 2b. Cutting lines 5, 6 extending partially through the height h_{1W} of the first wet foam deposition 10 are provided. A first set of cutting lines 5 are extending, parallel to each other, along the length l_{1W} of the first wet foam deposition 10, and a second set of cutting lines 6 are extending, parallel to each other, along the width w_{1W} of the first wet foam deposition 10. Both set of cutting lines 5, 6 have the same, even, spacing. By providing the cutting lines 5, 6 along both the direction of the width w_{1W} and the length l_{1W} of the first wet foam deposition 10, such that the cutting lines 5, 6 intersect each other, cuboid pillars 15 are formed. The top surface of each pillar 15 has a square shape.

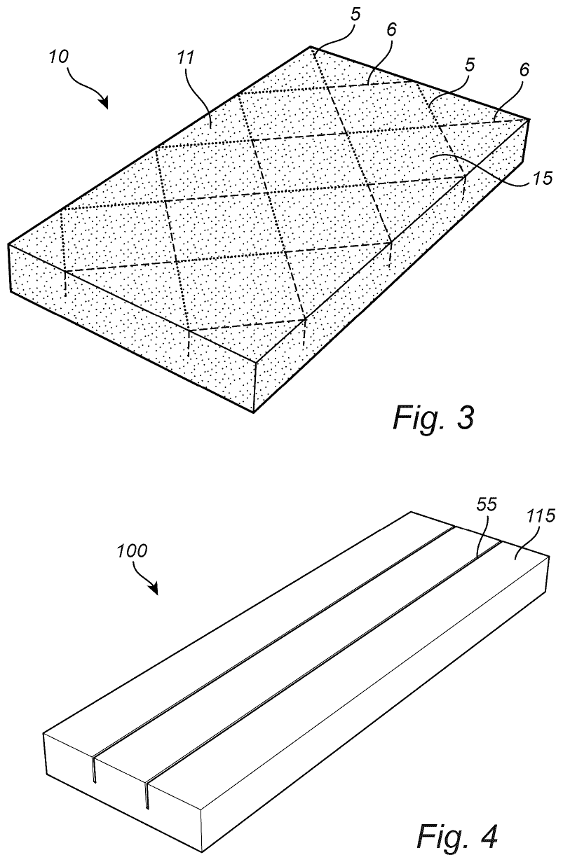

An alternative embodiment is illustrated in FIG. 3. Cutting lines 5, 6 extending in a zigzag-shape along the length of the first wet foam deposition 10 are provided. A first set of cutting lines 5 are provided, with a second set of cutting lines 6, off-set from the first set, subsequently being provided. A pattern of pillars 15 having a square top surface delimited by the cutting lines 5, 6 is formed in the top surface of the first wet foam deposition 10. By providing the cutting lines in a zigzag shape with adjacent cutting lines 5, 6 offset from each other, a simple way of producing pillars 15 of equal dimensions are obtained. Cutting is made only in one direction (i.e. along the length of the first wet foam deposition 10), which simplifies processing.

The cutting lines 5, 6 may be provided using any suitable method. For example, the cutting lines 5, 6 may be provided using a blade or knife. A mould with sharp edges may also be used. Preferably, the blade, knife or mould is made from a low friction material, such as PTFE, nylon or a smooth metallic material, to prevent the wet cellulose foam from sticking to the material.

In a preferred embodiment, the cutting lines 5, 6 are provided using air cutting. Air cutting utilizes cutting with an air jet of compressed air to provide cuts in a material. Compressed air is provided through a nozzle, the movements of which may be controlled by a computer. This enables high precision of the method. Several nozzles may be provided to increase the speed of the method by enabling simultaneous cutting. The pressure used may be in the range of from 0.1 to 5 bar, or from 0.25 to 4 bar. The cutting depth cd depends on the speed of the air used for cutting, the speed will in turn depend on parameters such as air pressure, size of the nozzle and the density of the wet cellulose foam. As realized by a person skilled in the art, the desired cutting depth cd can be obtained by selection of a suitable air pressure for the wet cellulose foam to be cut. The provided cutting lines 5, 6 are typically thin, the size will depend on the size of the nozzle and the air pressure. The width of a cutting line 5, 6 may typically be in the range of from 0.5 mm to 2.0 mm. Alternatively, the width of a cutting line 5, 6 may be in the range of from 5.0 to 15.0 mm, such as from 7.0 to 12.0 mm. Since the wet cellulose foam of the present invention is a soft material, it can be cut with high precision using only a jet of compressed air. No particles, such as abrasive particles, need to be included in the air jet.

The width of a cutting line 5, 6 typically depends on the means used for providing the cutting lines 5, 6. When knives or blades are used for providing the cutting lines, the width of a cutting line 5, 6 is typically in the range of from 5.0 to 15.0 mm, such as from 7.0 to 12.0 mm. Parameters such as applied pressure, speed of the process and density of the wet foam may have to be adjusted depending on the means used for providing the cutting lines 5, 6.

The wet cellulose foam in the first deposition 10 has a sufficiently high viscosity and low density in order to enable a wet foam that does not collapse before drying, also when the cutting lines 5, 6 have been provided.

Step d) of the method according to the first aspect involves drying the first wet foam deposition 10 so as to obtain a first solid foam deposition 100 comprising pillars 115 separated by gaps 55, wherein the gaps 55 are formed along the cutting lines 5, 6, and wherein the first solid foam deposition 100 has a height h_{1S}, a length l_{1S}, a width w_{1S}, a top surface 111 and a bottom surface 112.

Drying of the first wet foam deposition 10 may be carried out by evaporation at room temperature or at an elevated temperature, such as a temperature of from 40° C. to 140° C. Any suitable equipment may be used. After drying, the first solid foam deposition 100 may have a density of from 10 to 80 kg/m³, or from 10 to 60 kg/m³ or from 20 to 50kg/m³. The dry content of the first solid foam deposition 100 may be at least 95 wt %, as calculated based on the total weight of the first solid foam deposition 100.

During drying of the first wet foam deposition 10, the wet foam in the pillars 15 will contract to a certain extent since no restrictions, such as a frame, are present. This in turn leads to gaps 55 forming along the cutting lines 5, 6 during drying. The pillars 115 will after drying be separated by the gaps 55. After drying, pillars 115 of the first solid foam deposition 100 correspond in shape to the pillars 15 in the first wet foam deposition 10, but with a slight reduction in dimension in all directions due to contraction of the foam during drying. A height hₚ of the pillars 115 of the first solid foam deposition 100 may be in the range of from 90% to 100%, such as from 92% to 98%, of the cutting depth cd.

In one embodiment, as illustrated in FIG. 2c, the pillars 115 of the first solid foam deposition 100 are all of a cuboid shape. The dimensions of height, width and length are similar. In the embodiment illustrated in FIG. 2c, the pillars 115 have the same width and length along the entire height of the pillars 115.

In an alternative embodiment, as illustrated in FIG. 4, each pillar 115 may extend across the entire width or length of the solid cellulose foam deposition 100, so that a ribbed structure is formed. In the embodiment of FIG. 4, the length of the pillars 115 is significantly longer than the width.

After drying, the shape of the pillars 115 may be slightly distorted such that the dimensions are different at the top and bottom parts of each pillar 115. Due to the contraction of the wet foam during drying, the length and width at the top part of the pillars 115 may be smaller than the length and width at the bottom part of the pillars 115. For example, wet foam pillars of cuboid shape may contract during drying so that they after drying have the shape of a truncated pyramid.

During drying of the first wet foam deposition 10, non-uniform shrinkage in the height direction h_{1W} is minimized due to the presence of the cutting lines 5, 6. The formed pillars 15 are free standing during drying and does not collapse. During drying of the wet cellulose foam in the first wet foam deposition 10, a densified layer will form on the outer surface of the foam. This means that the formed pillars 115 will have a densified layer on their outer surfaces. The densified layer is a very thin layer that is formed on the very outer surface of the cellulose foam during drying. The densified layer is made up of cellulose fibres that are mainly oriented in a two-dimensional plane (x-y-plane), while the fibres in the bulk of the cellulose foam comprises clusters of fibres oriented in a three-dimensional space with more empty space in between clusters. The two-dimensional structure of cellulose fibres in the densified layer transitions rapidly, but gradually, to the three-dimensional structure found in the bulk of the cellulose foam. The thin thickness of the densified layer implies that it practically does not affect the overall density of the cellulose foam, while it still contributes to the good mechanical properties of the pillars 115. When the pillars 115 in the first solid foam deposition 100 have been dried, their core consists of a homogeneous fibre network having a density, and their outer surfaces, such as their bottom, top and side faces, consists of a more densely packed fibre network, i.e. the densified layer. The formation of a densified layer on the outer surfaces of the pillars 115 in the first foam deposition 100 makes the pillars 115 stronger and prevent them from being demolished during the subsequent deposition of the second wet cellulose foam between the pillars 115.

As the cellulose foam of the first wet foam deposition 10 contracts during drying, the cutting lines 5, 6 become wider, and gaps 55 are formed. The gaps 55 separate adjacent pillars 115 in the first solid foam deposition 100. The gaps 55 may have a uniform width (as illustrated in FIGS. 2c and 4), or the gaps 55 may be wider at the top than at the bottom. The width of the gaps 55 may be in the range of from 2 mm to 10 mm, as measured perpendicularly from an edge of the top surface of one pillar 115 to an edge of the top surface of an adjacent pillar 115.

The width w_{1S} and length l_{1S} of the first solid foam deposition 100 may be almost identical to the width w_{1W} and length l_{1W} of the first wet foam deposition 10, since the shrinkage of the foam in the width and length direction is typically negligible when the foam is dried on a surface (i.e. with restrictions). The height h_{1S} of the first solid foam deposition 100 may be from 90% to 100% of the height h_{1W} of the first wet solid foam deposition 10. The shrinkage that may occur is however uniform due to the presence of the pillars 15, and the height h_{1S} of the first solid foam deposition 100 does not vary along the length l_{1S} or width w_{1S} of the first solid foam deposition 100.

The height hₚ of the pillars 115 of the first solid foam deposition 100 may be from 70% to 100% of the height h_{1S} of the first solid foam deposition 100. In embodiments where the cutting lines 5, 6 are extending entirely through the height h_{1W} of the first wet foam deposition 10, the first solid foam deposition 100 will consist of a number of pillars 115, and the height of the pillars hp will be equal to the height h_{1S} of the first solid foam deposition 100.

In some embodiments, as illustrated in FIG. 2c, the first solid foam deposition 100 comprises a bottom portion 117 having a height h_{b} corresponding to from 5 to 30%, or from 5 to 20%, or from 5 to 15%, of the height h_{1S} of the first solid foam deposition 100, as measured from the bottom surface 112 of the first solid foam deposition 100, and wherein the pillars 115 extend from the bottom portion 117. In such embodiments, the cutting lines 5, 6 have extended only partially through the height h_{1W} of the first wet foam deposition 10. The sum of the height hₚ of the dry pillars and the height h_{b} of the bottom portion 117 equals the height h_{1S} of the first solid foam deposition 100. When the first solid foam deposition 100 comprises a bottom portion 117, the bottom surface 112 of the first solid foam deposition 100 will correspond to the bottom surface 312 of the solid cellulose foam 300. In embodiments with a bottom portion 117, the bottom surface 112, 312 will be coherent. A coherent bottom surface 112, 312 is more visibly pleasing than one interrupted by pillars 115 and gaps 55, it is also smooth and uniform which is desirable in many applications.

In an alternative embodiment the drying in step d) involves at least partially drying the first wet foam deposition 10. In such embodiments, an at least partially dried first foam deposition is formed. The first wet foam deposition must be sufficiently dry so that it does not collapse when depositing the subsequent wet foam deposition. The dry content of the at least partially dried first foam deposition may be at least 75 wt %, or at least 85 wt %, as calculated based on the total weight of the at least partially dried first foam deposition. The at least partially dried first foam deposition is in such embodiments dried together with the second wet foam deposition in the second drying step to obtain a solid (i.e. fully dried) foam deposition. The at least partially dried first foam deposition is also regarded a solid foam deposition, and all features described in relation to the solid first foam deposition applies also to the at least partially dried first foam deposition. By only partially drying the first wet foam deposition, the total drying time of the foam is reduced since parts of the first wet foam deposition is dried together with the second wet foam deposition. This reduces the energy consumption required in the process.

Step e) of the present invention involves providing a second wet cellulose foam, the details of which are further described above. In one embodiment, the second wet cellulose foam is identical to the first wet cellulose foam used in the first foam deposition 10. When the first and second wet cellulose foams are identical, manufacturing is simplified.

In other embodiments, the second wet cellulose foam is different from the first wet cellulose foam, for example in terms of composition or density. The final properties of the solid cellulose foam 300 can be tailormade by providing wet cellulose foams with different properties.

Step f) of the present invention involves depositing the second wet cellulose foam so as to obtain a subsequent wet foam deposition 20 that fills the gaps 55 between the pillars 115 of the first solid foam deposition 100. To ensure that no voids are present within the solid cellulose foam 300, it is important to ensure that the second wet cellulose foam completely fills the gaps 55 separating the pillars 115 of the first solid foam deposition 100. After deposition of the second wet cellulose foam, the pillars 115 of the first solid foam deposition 100 are embedded in the wet cellulose foam of the subsequent deposition 20. The second wet cellulose foam may be deposited using any suitable means, such as by extrusion.

In one embodiment, vacuum is applied during deposition of the second wet cellulose foam, to ensure that the gaps 55 are entirely filled with the second wet foam deposition 20. In such embodiments, the air pressure on the bottom side of the first solid foam deposition 100 is decreased when the second wet cellulose foam is deposited. This means that the wet cellulose foam will be forced into the gaps 55 by the difference in air pressure. The difference in air pressure must be large enough to overcome the yield stress of the wet cellulose foam and initiate flow, and also large enough to force the wet foam into the narrow gaps. To ensure that the vacuum does not cause expansion and subsequent collapse of bubbles in the second wet cellulose foam, the vacuum must be low. If the applied vacuum is too high, the gas in each bubble in the foam would expand with great force in order to occupy the volume that the gas would have in equilibrium at such low pressure. The foam would break due to the strain of such expansion. Vacuum-assisted deposition is facilitated by the wet cellulose foam being impermeable to air, while the solid cellulose foam is air-permeable. Therefore, vacuum-assisted deposition is possible also in embodiments where the first solid foam deposition 100 comprises a coherent bottom portion 117.

Since the vacuum applied is low, water is not removed from the wet foam. The purpose of the applied vacuum is only to facilitate filling the gaps, not dewatering of the wet foam.

As an alternative to applying vacuum during deposition of the second wet cellulose foam, the wet foam may be pushed down in the gaps 55 with increased air pressure, with mechanical means or by an increase in pressure within the wet foam itself.

In some embodiments, an increased air pressure is applied on top of the second wet cellulose foam to force the foam down into the gaps 55.

In some embodiments, mechanical means, such as a scrape or roller, is used to mechanically force the second wet cellulose foam down into the gaps 55.

In some embodiments, the second wet foam has an increased pressure. When the second wet foam exits the depositor, it is pressurized which will facilitate filling of the gaps 55 between the pillars 115 of the first deposition 100. Filling the gaps 55 is further facilitated if other paths than going down into the gaps 55 are at least partially restricted. One way to partially restrict other paths is to put a pipe collar on an exit pipe from the depositor and position the exit pipe close to the gaps 55 to be filled.

A height h_{2W} of the subsequent wet foam deposition 20 may be equal to or greater than the height hₚ of the pillars 115 of the first solid foam deposition 100. For example, the height h_{2W} of the subsequent wet foam deposition 20 may be from 100% to 120% of the height hₚ of the pillars 115 of the first solid foam deposition 100.

In some embodiments, the height h_{2W} of the subsequent wet foam deposition 20 is equal to the height hₚ of the pillars 115 of the first solid foam deposition 100. In such embodiments, the top surface 311 of the solid cellulose foam 300 will comprise the top surface of the pillars 115 surrounded by the subsequent solid foam deposition 200 filing the gaps 55 between the pillars 115.

In some embodiments, as illustrated in FIG. 2d showing an intermediate product 30, the height h_{2W} of the subsequent wet foam deposition 20 is greater than the height hₚ of the pillars 115 of the first solid foam deposition 100. For example, the height h_{2W} of the subsequent wet foam deposition 20 may be from 105% to 120% of the height hp of the pillars 115 of the first solid foam deposition 100. The portion of the subsequent wet foam deposition 20 that is arranged on top of the pillars 115 forms a top portion 27 of the subsequent wet foam deposition 20. Such a top portion 27 ensures that the top surface 311 of the solid cellulose foam 300 is coherent and smooth. In embodiments where the subsequent wet foam deposition 20 comprises a top portion 27, the pillars 115 are not visible from the top surface 312 of the solid cellulose foam 300.

The width w_{2W} and the length l_{2W} of the subsequent wet foam deposition 20 are preferably equal to the width w_{1S} and length l_{1S} of the first solid foam deposition 100.

Step g) of the method according to the first aspect involves drying the subsequent wet foam deposition 20 so as to obtain a solid cellulose foam 300 comprising pillars 115 of a first solid foam deposition 100 and a subsequent solid foam deposition 200 filling the gaps 55 between the pillars 115. After drying of the subsequent wet foam deposition 20, the pillars 115 of the first solid foam deposition 100 are embedded in the subsequent solid foam deposition 200. The subsequent solid foam deposition 200 completely fills the gaps between the pillars of the first solid foam deposition 100, so that there are no voids in the solid cellulose foam 300.

Drying of the subsequent wet foam deposition 20 may be carried out by evaporation at room temperature or at an elevated temperature, such as a temperature of from 40° C. to 140° C. Any suitable equipment may be used. After drying, the subsequent solid foam deposition 200 may have a density of from 10 to 80 kg/m³, or from 10 to 60 kg/m³ or from 20 to 50 kg/m³. The dry content of the subsequent solid foam deposition 200 may be at least 95 wt %, as calculated based on the total weight of the subsequent solid foam deposition 200.

The pillars 115 provide support for the second wet cellulose foam in the subsequent deposition 20 during drying, ensuring that shrinkage is minimized.

In a wet cellulose foam, resistance forces keep the cellulose fibres in place. During drying, the water level between the fibres recedes causing capillary forces to build up inside the foam material, and when the capillary forces exceed the resistance forces, the fibres slip. As water evaporates, the resistance forces increase and causes the fibres to get stuck in a position closer to each other than before drying, which causes the material to shrink. On a macroscopic level, the geometry of the wet cellulose foam influences the direction and magnitude of tension vectors that build up in the material during drying. Points of contact, such as a frame or a perforated mould, causes tension in the opposite direction and will impact the net tension forces. Deformation, such as shrinkage, will occur when the net tension forces, i.e. the tension vector, dominate in any particular direction. Thus, the ratio of width to height of the wet cellulose foam deposition affects the distribution of the net tension forces in the foam upon drying, and the greater the ratio, the greater the net tension forces that arise.

The method according to the first aspect of the present invention reduces the net tension forces arising in the first wet cellulose foam upon drying since the pillars 15 each have a low width to height ratio. Non-uniform shrinkage of the wet cellulose foam in the pillars 15 in the height direction may thus be minimized or avoided. In comparison to drying of a large wet cellulose foam deposition with a large surface area, the surface area of the first wet foam deposition 10 in the present invention is divided into a multitude of pillars 15, each having a relatively small surface area, with a favourable width to height ratio. When the pillars 15 are dried, they will consist of a core comprising a homogeneous fibre network, and densified outer faces (i.e. the top, bottom and sides). A subsequent deposition of a second wet cellulose foam is then made between the already dried pillars 115. When the wet foam of the subsequent deposition 20 is being dried, the pillars 115 of the first deposition 100 that are already distributed on the surface provide for a low width to height ratio of the wet cellulose foam in the subsequent deposition 20. The tension forces of each pillar 115 will act against each other thus reducing the net tension forces in the wet foam of the subsequent deposition 20, which restrains build-up of the tension during drying and as a result mitigates the effect of shrinkage on the outer dimensions of the obtained solid cellulose foam 300. The method of the present invention thus provides for formation of a solid cellulose foam object 300 with uniform height hₛ, since non-uniform shrinkage in the thickness (i.e. height) direction is minimized. Further, the present method allows for the formation of a foamed object without having to use a mould with walls, which implies that very large objects can be produced with this method, such as boards or planks for use in large constructions, such as buildings, and other large structures.

The obtained solid cellulose foam 300, as illustrated in FIG. 2e, has a height hₛ, a length lₛ, and a width wₛ. The solid cellulose foam 300 may have a density of from 10 to 80 kg/m³, or from 10 to 60 kg/m³ or from 20 to 50kg/m³. The dry content of the solid cellulose foam 300 may be at least 95 wt %, as calculated based on the total weight of the solid cellulose foam 300. The solid cellulose foam 300 may comprise cellulose fibres in a range of from 71 to 95 wt % based on the total dry weight of the solid cellulose foam 300. In one embodiment, the solid cellulose foam 300 comprises cellulose fibres in a range of from 71 to 95 wt % based on the total dry weight of the solid cellulose foam 300, a water-soluble thickener in a range of from 4 to 24 wt % based on the total dry weight of the solid cellulose foam 300, and at least two surfactants.

The height hₛ of the solid cellulose foam 300 may be in the range of from 1 to 20 cm, or from 1 to 10 cm, or from 1 to 6 cm, or from 4 to 6 cm. The width wₛ and length lₛ of the solid cellulose foam 300 are not particularly limited, but may both be in the range of from 60 cm to 400 cm, such as from 100 cm to 300 cm, depending on the equipment used for production and the desired dimensions. In preferred embodiments, the solid cellulose foam 300 is in the shape of a plank.

The size and number of pillars 115 in the first solid cellulose foam deposition 100 may vary depending on the size of the solid cellulose foam 300 and the required properties.

The height hₚ of the pillars 115 may be from 60 to 100% of the height hₛ of the solid cellulose foam 300. In some embodiments, pillars 115 extend from the top surface 311 of the solid cellulose foam 300 to the bottom surface 312 of the solid cellulose foam 300, i.e. the height hₚ of the pillars 115 is equal to the height hₛ of the solid cellulose foam 300. In such embodiments, the height h_{1S} of the first solid foam deposition 100, the height h_{2S} of the subsequent solid foam deposition 200 and the height hₛ of the solid cellulose foam 300 are all equal. In such embodiments, the pillars 115 are visible both from the top surface 311 and from the bottom surface 312 of the solid cellulose foam 300. The top surface 311 of the solid cellulose foam 300 will in such embodiments consist of the top surface of the first solid cellulose foam deposition 100 (i.e. the pillars), and the top surface of the subsequent solid foam deposition 200 (i.e. in the gaps between the pillars). Similarly, the bottom surface 312 of the solid cellulose foam 300 will in such embodiments consist of the bottom surface of the first solid cellulose foam deposition 100 (i.e. the pillars), and the bottom surface of the subsequent solid foam deposition 200 (i.e. in the gaps between the pillars).

In some embodiments the height hₚ of the pillars 115 may be from 60 to 95%, such as from 70 to 95%, or from 70 to 90%, of the height hₛ of the solid cellulose foam 300. In such embodiments, either the top surface 311 or the bottom surface 312, or both, of the solid cellulose foam 300 is coherent, with the pillars 115 not being visible.

In some embodiments, the first solid foam deposition 100 further comprises a bottom portion 117, extending from a bottom surface 312 of the solid cellulose foam 300, and wherein the pillars 115 are extending from the bottom portion 117. The bottom portion 117 is coherent, and the pillars 115 are not visible from the bottom surface 312 of the solid cellulose foam 300. The height h_{b} of the bottom portion 117 may be from 5 to 30% of the height h_{1S} of the first solid foam deposition 100. In embodiments where the first solid foam deposition 100 comprises a bottom portion 117, the bottom surface 312 of the solid cellulose foam 300 will correspond to the bottom portion 112 of the first solid foam deposition 100.

In some embodiments, the subsequent solid foam deposition 200 further comprises a top portion 217, arranged on top of the pillars 115. The top portion 217 is coherent, and the pillars 115 are not visible from the top surface 311 of the solid cellulose foam 300. The height hₜ of the top portion 217 may be from 5 to 15%, such as from 7 to 12%, of the height hₛ of the solid cellulose foam 300.

In a preferred embodiment, such as illustrated in FIG. 2e, the first solid foam deposition 100 comprises a bottom portion 117, and the subsequent solid foam deposition 200 comprises a top portion 217. This ensures that both the top surface 311 and the bottom surface 312 of the solid cellulose foam 300 are coherent and smooth. It also improves the mechanical properties of the solid cellulose foam 300, since there is less risk of damage, such as breakage, along the intersection between the first and subsequent solid foam depositions 100, 200. In such embodiments, the height of the solid cellulose foam hₛ is equal to the sum of the height hₚ of the pillars 115, the height hₜ of the top portion 217 and the height h_{b} of the bottom portion 117.

The present invention provides for a low-density cellulose foam comprising a first solid foam deposition 100 comprising pillars 115 with stiffer densified cellulose fibre walls, with the gaps 55 between pillars 115 filled with a subsequent solid foam deposition 200. The incorporation of the pillars 115 as structural elements in solid foams, enables the formation of stiffer foams while maintaining the same low density. The cellulose foam 300 is dimensionally stable since the pillars 115 prevent the typical shrinkage behaviour of cellulose foams, with a pronounced shrinkage in the thickness direction towards the middle of an object.

In one embodiment, the density of the first foam deposition is higher than the density of the subsequent foam deposition. For example, the density of the first foam deposition may be at least 110%, such as 130%, or 150% or 200%, higher than the density of subsequent foam deposition. In one embodiment, the density of the first foam deposition may be in the range of from 105 to 500%, or 110 to 330%, or 110 to 250%, or 110 to 200%, or 150 to 330% higher than the density of the subsequent foam deposition.

When the density of the first wet foam deposition 10 is higher than the density of the subsequent wet foam deposition 20, it has been found that the total drying time of the foam decreases, thus enabling a more efficient process. In addition, the higher density regions of the foam (i.e. the pillars 115 and optional bottom portion 117) will have different properties, for example stiffness, compared to the lower density regions (i.e. the foam in the gaps 55 and optional top portion 217). This can be used to provide a solid cellulose foam 300 with different properties in different regions.

The density of the wet cellulose foam depends on how much air that is included during foaming. If a low density is desired, relatively more air should be included. If a high density is desired, relatively less air should be included. The density of the wet cellulose foam will have a direct influence on the density of the solid cellulose foam after drying. Thus, density differences between the wet foams of the first deposition 10 and the subsequent deposition 20 will remain also in the solid foam depositions 100,200.

In some embodiments, a coating may be applied to any surface of the solid cellulose foam 300, and/or to the first or subsequent solid foam deposition(s) 100, 200. The coating is preferably applied in the form of a liquid coating composition, and one or several coating layers can be applied. The composition of the coating layers may be the same or different. The coating may comprise at least one particulate material and at least one film-forming material. The particulate material may be selected from at least one of microfibrillated cellulose (MFC), cellulose fibres or mineral particles such as clay or calcium carbonate. MFC shall in the context of the present application mean a cellulose particle, fibre or fibril having a width or diameter of from 20 nm to 1000 nm. The film-forming material may be selected from at least one of carboxymethyl cellulose (CMC), cellulose ethers, starch, polyvinyl alcohol or synthetic latexes, such as acrylic or styrene-butadiene latexes. The coating may comprise at least one hydrophobic agent, for example selected from at least one of a wax, such as bee's wax or carnauba, alkyl ketene dimer (AKD) or alkyl succinic anhydride (ASA).

By application of a coating, the air permeability of the solid cellulose foam decreases since pores on the surface of the foam are closed by the coating. This facilitates various processing and converting operations involving vacuum. In addition, and depending on the type of coating, properties such as strength and hydrophobicity of the solid cellulose foam may be altered by application of a coating. The coating is preferably applied to a surface of the foam comprising a densified layer.

According to a second aspect, the present invention relates to a solid cellulose foam 300 having a height hₛ, a length lₛ, and a width wₛ, the solid cellulose foam 300 comprising a first solid foam deposition 100 and a subsequent solid foam deposition 200, wherein the first solid foam deposition 100 comprises pillars 115, wherein the pillars 115 are separated by gaps 55, and wherein the gaps 55 are filled with the subsequent solid foam deposition 200. The solid cellulose foam 300 according to the second aspect may be produced by the method according to the first aspect. The solid cellulose foam 300 according to the second aspect may be further defined as set out above with reference to the first aspect.

According to a third aspect, the present invention relates to a use of the solid cellulose foam 300 according to the second aspect as a packaging material or a building material. The solid cellulose foam 300 of the present invention has excellent cushioning properties which are desirable in the field of protective packaging. In addition, it may be used as a building material, for example to provide thermal insulation or acoustic insulation.

### EXAMPLES

### Example 1

### Air-Cutting to Generate Pillars of Foam for a Small Thin Dry Cellulose Foam Sheet

To achieve a first deposition of wet cellulose foam in the form of pillars, a uniform wet paste was prepared comprising 15 wt % cellulose pulp (softwood kraft bleached pulp) in water and a thickener (CMC). The paste was aerated with a surfactant mixture (myristic acid and sodium cocoyl sarcosinate) until a wet foam density of 160 kg/m³ was obtained. The wet foam was deposited onto a flat tray in a frame of dimension 43*24*2 cm, and scraped into an even thickness of 2 cm with the help of a flat scraper. The foam was filling the whole frame with no voids.

Afterwards the foam was cut with the help of 16 air nozzles facing downwards perpendicular to the foam surface. The nozzles where fixated in a row with 25 mm in between each nozzle exit. The exit pipe of each nozzle had a diameter of 0.75 mm and was sufficiently long to achieve a directed air beam. The nozzles were connected to pressurized air with the pressure of 0.5 bar and placed at a height 3 mm above the foam. The foam was moved in the horizontal plane along its width direction, with a speed of 0.2 m/s, passing under the row of nozzles, forming parallel cuts 25 mm apart in the wet foam. The cuts were perpendicular to the side of the foam. The foam was then turned 90° and cut again with the same row of nozzles.

For the second cutting the foam was thus moved along its length direction, with the same procedure as for the first cutting, forming parallel cuts that were crossing the first cuts. The cut-out pattern was a square grid pattern, and the cuts became deeper than 70% of the foam height but did not cut right through the foam. Both the first set of cuts and the second set of cuts were continuous, extending from one side of the wet foam to the opposite side. The cut out pillars were therefore of cuboid shape and connected in the bottom part of the wet foam deposition.

The wet foam deposition was dried in an ordinary convection oven at 120° C. for 2 hours. For the subsequent deposition, a new batch of wet cellulose foam was prepared following the above description for the wet cellulose foam used in the first deposition. The wet foam was filled in the gaps between the pillars with the help of a low vacuum. The wet foam was spread out on top of the dry foam in the first deposition, and vacuum was applied from beneath. Since the dry foam is air permeable this technique allowed vacuum to pull the wet foam down into all voids. The surface was scraped to remove any possible extra foam and levelling out the surface to the height of the frame. The wet foam of the subsequent deposition covered all the pillars, so that the top surface of the foam consisted only of a thin layer of the subsequent deposition. Finally, the foam was dried in the oven at 120° C. for 1 hour. The density of the final foam sheet was ~34-38 kg/m³.

The final thickness of the foam sheet was ~2 cm and no shrinkage was observed. The shrinkage is calculated based on the difference of the thickness in the centre of the foam and near the edges of the foam.

### Example 2 (Comparative Example)

### Single-Step Deposition

A uniform wet paste comprising 15 wt % cellulose pulp (softwood kraft bleached pulp) in water and a thickener (CMC) was prepared. The paste was aerated with a surfactant mixture (myristic acid and sodium cocoyl sarcosinate) until a wet foam density of 180 kg/m³ was obtained.

A mould having dimensions of 43*24*2 cm was filled with the aerated wet foam and the surface was scraped to remove any extra foam and levelling out the surface to the height of the frame. Finally, the foam is dried in an ordinary convection oven at 120° C. for 3 hours.

The density of the dried foam object was ~30-33 kg/m³ and a shrinkage of 15% was observed in the centre of the foam object. The shrinkage is calculated based on the difference of the thickness in the centre of the foam and near the edges of the foam.

### Example 3

### Air-Cutting to Generate Pillars of Foam for a Large Thick Dry Foam Sheet

A uniform wet paste comprising 15 wt % cellulose pulp (softwood kraft bleached pulp) in water and a thickener (CMC) was prepared. A surfactant mixture (myristic acid and sodium cocoyl sarcosinate) was added to the paste and the obtained mixture was extruded and simultaneously aerated to obtain an extruded wet foam with a density of 160kg/m³.

The wet foam was deposited onto a flat tray in a frame of dimension 114*76*5 cm, and scraped into an even thickness of 5 cm with the help of a flat scraper. The foam was filling the whole frame with no voids. Afterwards the foam was cut with the help of 25 air nozzles facing downwards perpendicular to the foam surface. The nozzles where fixated in a row with 50 mm in between each nozzle exit. The exit pipe of each nozzle had a diameter of 1.0 mm and was sufficiently long to achieve a directed air beam. The nozzles were connected to pressurized air with the pressure of 1.5 bar and placed at a height 5 mm above the foam.

The foam was moved in the horizontal plane along its width direction, with a speed of 0.02 m/s, passing under the row of nozzles, forming parallel cuts 50 mm apart in the wet foam. The foam was then turned 90° and cut again with the same row of nozzles. For the second cutting the foam was thus moved along its length direction, with the same procedure as the first cutting, forming parallel cuts that were crossing the first cuts. Both the first set of cuts and the second set of cuts were continuous, extending from one side of the wet foam to the opposite side. The cut-out pattern was a square grid pattern, and the cuts became deeper than 70% of the foam height but did not cut right through the foam. The cut out pillars were therefore of cuboid shape and connected in the bottom part of the wet foam.

The first foam deposition was dried in an ordinary convection oven at 80° C. for 16 hours. For the subsequent deposition, a new batch of wet foam was prepared following the above description for the wet foam used in the first deposition. The wet foam was filled in the space between the discrete units with the help of a slit nozzle placed in close proximity to the dry material. The surface was scraped to remove any possible extra foam and levelling out the surface to the height of the frame. The wet foam of the subsequent deposition covered all the pillars, so that the top surface of the foam consisted only of a thin layer of the subsequent deposition. Finally, the foam was dried in the oven at 80° C. for 16 hours. The density of the dried final foam sheet was ~32-36 kg/m³. The final thickness of the foam sheet was ~5 cm and no shrinkage was observed. The shrinkage is calculated based on the difference of the thickness in the centre of the foam and near the edges of the foam.

### Example 4

### Drying Time of Foam Manufactured With Two-Step Deposition

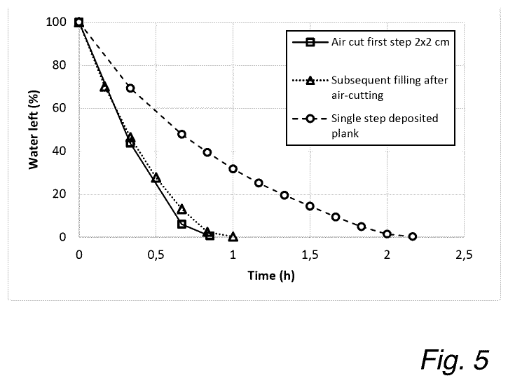

A wet cellulose foam (comprising (based on dry weight) 88 wt % softwood bleached kraft pulp, 10 wt % CMC and a surfactant mixture of myristic acid and cocoyl sarcosinate) having a dry content of 15 wt % and a density of 154 kg/m³ was deposited in a wooden frame (2.1×24.5×43.5 cm) on a perforated tray. The surface was made even by scraping the top with a scraper resting on the frame. With the help of air-cutting the foam was cut into pillars in a square grid pattern with each piece being 2×2 cm. The air cutting is performed as described in example 1, but with 2 cm between each cut instead of 2.5 cm, and the cutting was performed such that the formed pillars were completely separated from each other using an air pressure of between 1 and 1.5 bar. The obtained first foam deposition was dried in an oven at 120° C. During drying, the foam was weighted at several points in time. The obtained drying curve is shown in FIG. 5 (air cut first step 2×2 cm). The drying time of the first foam deposition was 50 minutes.

After drying of the first foam deposition, a second wet cellulose foam with the same composition and properties as the foam used for the first foam deposition was applied on top of the dry first foam deposition. Vacuum was applied from below to ensure that the wet foam filled the gaps between the pillars of the first foam deposition. The wet foam, still confined within the same wooden frame, was scraped to make the surface even. The resulting foam plank was dried using the same conditions as for the first foam deposition. Again, the foam was weight at several points in time. The obtained drying curve is shown in FIG. 5 (subsequent filling after air cutting). The drying time of the subsequent foam deposition was 49 minutes.

The total amount of water that evaporated in the two consecutive drying steps was 390 g. The total drying time of the foam was 99 minutes. After both drying steps the density of the foam was 38kg/m³.

### Example 5 (Comparative example)

### Drying Time of Foam Manufactured With Single-Step Deposition

A reference foam with higher foam density was used to make a reference foam plank in the same frame as described in example 4. The composition and dry content of the reference foam was the same as described for the foam in example 4.

The wet cellulose foam used in example 5 contained a similar amount of water as the amount of water evaporated during drying of the foam in example 4. The wet cellulose foam had a density of 206 kg/m³. The reference plank was dried as described in example 4, the foam plank was weighted at several point in time. The obtained drying curve is shown in FIG. 5 (single step deposited plank). The density of the dry foam was 39 kg/m³. The drying time was 124 minutes.

Thus, the total time required for removing the same amount of water is shorter when using a two-step deposition method than a single-step deposition method.

### Example 6

### Drop Testing of Foams Manufactured Using Two-Step or Single-Step Deposition

Foams were prepared as described in examples 4 and 5, except that the dry content of the wet cellulose foams was 12 wt % (corresponding to a density of 193 kg/m³ ).

The solid foams were evaluated in terms of the degradation during impact. The degradation was evaluated by drop testing the foams with a static load of 12 g/cm² falling from a height of 76 cm. Degradation was measured as the relative compression after 5 drops. Two stacked test pieces of 20×20×2 cm were placed under the static load that was dropped on top of them. The average height of the two test pieces was measured before and after dropping five times so that the degradation could be calculated. Prior to testing, the sample foam pieces were conditioned at 20° C. and 20% RH (relative humidity), so that a density of 38 kg/m³ was obtained.

The foam manufactured with two-step deposition (as in example 4) showed a degradation of 13%, and the foam manufactured with one-step deposition (as in example 5) showed a degradation of 18%. Thus, the foam manufactured using a two-step deposition method had better cushioning properties.

In view of the above detailed description of the present invention, other modifications and variations will become apparent to those skilled in the art.

However, it should be apparent that such other modifications and variations may be effected without departing from the spirit and scope of the invention.

1. A method for producing a solid cellulose foam having a height hₛ, a length lₛ, and a width wₛ, wherein the method comprises the steps of:
a) providing a first wet cellulose foam;
b) depositing the first wet cellulose foam on a surface, so as to obtain a first wet foam deposition having a height h_{1W}, a length l_{1W}, a width w_{1W}, a top surface and a bottom surface;
c) forming pillars in the first wet foam deposition by providing the top surface of the first wet foam deposition with cutting lines extending at least partially through the height h₁ of the first wet foam deposition;
d) drying the first wet foam deposition so as to obtain a first solid foam deposition comprising the pillars separated by gaps, wherein the gaps are formed along the cutting lines, and wherein the first solid foam deposition has a height h_{1S}, a length l_{1S}, a width w_{1S}, a top surface and a bottom surface;
e) providing a second wet cellulose foam;
f) depositing the second wet cellulose foam so as to obtain a subsequent wet foam deposition that fills the gaps between the pillars in the first solid foam deposition; and,
g) drying the second wet foam deposition so as to obtain a solid cellulose foam comprising pillars of the first solid foam deposition and the subsequent solid foam deposition filling the gaps between the pillars.

2. The method according to claim 1, wherein the cutting lines are made with air cutting.

3. The method according to claim 1, wherein the cutting lines are made using a blade or knife.

4. The method according to claim 1, wherein the cutting lines are provided in a direction of the length l_{1W}, or width w_{1W}, or both of the first wet foam deposition.

5. The method according to claim 1, wherein the cutting lines extend to a cutting depth cd corresponding to at least 70% of the height h_{1W} of the first wet foam deposition, as measured from the top surface of the first wet foam deposition towards the bottom surface of the first wet foam deposition.

6. The method according to claim 1, wherein the cutting lines extend to a cutting depth cd corresponding to in the range of from 70% to 95% of the height h_{1W} of the first wet foam deposition, as measured from the top surface of the first wet foam deposition towards the bottom surface of the first wet foam deposition.

7. The method according to claim 6, wherein the first solid foam deposition comprises a bottom portion having a height h_{b} in a range of from 5% to 30% of the height h_{1S} of the first solid foam deposition, as measured from the bottom surface of the first solid foam deposition, and wherein the pillars extend from the bottom portion.

8. The method according to claim 1, wherein a vacuum is applied during the depositing of the second wet cellulose foam.

9. The method according to claim 1, wherein a height h_{2W} of the subsequent wet cellulose foam deposition is greater than the height hₚ of the pillars of the first solid foam deposition.

10. The method according to claim 1, wherein the first wet cellulose foam and the second wet cellulose foam both comprise cellulose fibres in a range of from 71 to 95 wt % based on a total dry weight of the respective wet cellulose foam, a water-soluble thickener in a range of from 4 to 24 wt % based on the total dry weight of the respective wet cellulose foam, and at least two surfactants.

11. A solid cellulose foam having a height hₛ, a length lₛ, and a width wₛ, the solid cellulose foam comprising:
a first solid foam deposition; and
a subsequent solid foam deposition,
wherein the first solid foam deposition comprises pillars,
wherein the pillars are separated by gaps, and
wherein the gaps are filled with the subsequent solid foam deposition.

12. The solid cellulose foam according to claim 11, wherein a height hₚ of the pillars is from 0.6 to 1.0 times the height hₛ of the solid cellulose foam.

13. The solid cellulose foam according to claim 11, wherein the first solid foam deposition further comprises a bottom portion, extending from a bottom surface of the solid cellulose foam, and
wherein the pillars extend from the bottom portion.

14. The solid cellulose foam according to claim 11, wherein the subsequent solid foam deposition further comprises a top portion arranged on top of the pillars.

15. The solid cellulose foam according to claim 11, wherein a density of the solid cellulose foam is in range of from 10 to 80 kg/m³.

16. The solid cellulose foam according to claim 11, wherein the solid cellulose foam comprises cellulose fibres in a range of from 71 to 95 wt % based on a total dry weight of the solid cellulose foam, a water-soluble thickener in a range of from 4 to 24 wt % based on the total dry weight of the solid cellulose foam, and at least two surfactants.

17. The solid cellulose foam according claim 11, wherein the solid cellulose foam forms a packaging material, a building material, a thermal insulation material, an acoustic insulation material, or a hydroponic plant growth media.
